(19) United States
(12) Patent Application Publication
(10) Pub. No.: US 2004/0177382 A1
(43) Pub. Date: Sep. 9, 2004

(54) Data broadcasting system and operating method thereof

(76) Inventor: Mi Ae Choi, Incheon-si (KR)

Correspondence Address: BIRCH STEWART KOLASCH & BIRCH, PO BOX 747, FALLS CHURCH, VA, 22040-0747, US

(21) Appl. No.: 10/790,046

(22) Filed: Mar. 2, 2004

(30) Foreign Application Priority Data
Mar. 3, 2003 (JP) 10-2003-0012986

(51) Int. Cl. H04N 5/445; G06F 3/00; H04N 7/10; H04N 9/44; H04N 5/04; H04N 7/16; H04N 7/173; H04N 7/025

(52) U.S. Cl. 725/135; 725/42; 725/32; 725/86; 348/500; 715/500.1

(57) ABSTRACT

Disclosed are a data broadcasting system and an operating method thereof that can provide advertisement while a viewer receives data with a delay. A method for operating a data broadcasting system of the present invention includes the steps of: downloading a data service table for a specific application at the client; providing an advertisement and performing a data receiving process at the same time with reference to the data service table; and executing the specific application using data files extracted through the data receiving process.

### BACKGROUND OF THE INVENTION

1. Field of the Invention

The present invention relates to a data broadcasting system and an operating method thereof, and more particularly, to a data broadcasting system and an operating method thereof that can provide advertisement while data reception is delayed.

2. Description of the Related Art

A digital broadcast is a common name that implies all the broadcasts transmitted digitally. The U.S. has decided to adopt a digital technology for a next generation television called advanced television (ATV). In Europe, a lot of projects such as HD DRIVINE in Sweden, SPECTRE in U.K., DIAMOND in France, etc. are in progress. Such digital broadcast systems are actively being studied in various countries as next generation systems that interwork with B-ISDN or a computer network.

Generally, a stream transmitted in the digital broadcast can carries video/audio signal and data information. Here, data information can be made based on a markup language such as HTML of Advanced Television Enhancement Forum (ATVEF) and XDML of Digital TV Application Software Environment) DASE or based on Java such as Xlet of DASE.

A viewer can obtain additional information on a program, purchase goods by simple manipulation, search for interesting information such as weather, share, news, etc., and use a banking service at home during watching a television through the data broadcast for the data information. In addition, the viewer can make active participation. For example, the viewer participates in a live quiz program to win a prize according to their points, gives an account for news, or reflects his or her opinion to a broadcast program.

Accordingly, the above-mentioned digital broadcast can provide various types of data information besides video or audio provided by the conventional analogue broadcast.

The digital broadcasts can be classified into a terrestrial broadcast, a satellite broadcast and a cable broadcast according to their specifications.

Such broadcasts as a terrestrial broadcast, a satellite broadcast and a cable broadcast have different broadcast standards according to countries. For example, Korea adopts Advanced Television System Committee (ATSC) for the terrestrial broadcast and Digital Video Broadcasting (DVB) for the satellite broadcast, and provisionally adopts Open Cable Application Platform (OCAP) for the cable broadcast. ATSC has been adopted by North America. DVB has been adopted by Europe.

8-Vestigial Side Band (VSB) of the ATSC system has been developed in the U.S. and adopted for the terrestrial broadcast as the digital broadcast specification. The ATSC system adopts some properties similar to those of an NTSC system for the conventional analogue system so that a transmitter and a receiver are easy to configure or it is economically advantageous.

The DVB system was adopted in Europe for the satellite broadcast as the digital broadcast specification and has been widely used. The DVB system is becoming a global standard for a digital broadcast of a video, an audio and data.

The OCAP system is adopted for the cable broadcast as the digital broadcast specification and is a standard that an application for bi-directional service of the cable broadcast is produced on the basis of. The OCAP system can provide a web-based service for a broadcast and support an advanced bi-directional service.

In general, the broadcasting station for supporting North American style or European style data broadcast transmits multimedia platform-specific applications along with digital broadcast programs if possible.

The properly configured multimedia platform-specific set-top box can receive and perform such applications locally.

Such applications includes an electronic program guide, play-along games, tele-banking, tele-shopping, electronic newspaper and other information services, for example.

The multimedia platform applications are broadcasted by using object carousel. Here, all the application codes and data are circulated and broadcasted.

Today, in the digital broadcast systems, a transmitter transmits typically very many services (or channels) to a plurality of receivers (found in set-top boxes, for example). Such a service can include an audio/video stream, interactive application, and other kinds of data.

The transmitter packetizes an elementary stream into a packet primarily to generate a packetized elementary stream (PES) packet, and transforms the PES packet into 188-byte transport stream packet to transmit the elementary stream in the form of series of transport stream packets. This transport stream can include audio, video and data information (e.g. application). Here, the transport stream can include program specific information (PSI).

As described above, the applications transmit consecutive data sections in a transport stream form. The consecutive data sections are repeated periodically and sequentially. Here, the transmitter transmits a data service table (DST) including information on the application before transmitting the consecutive data sections. Accordingly, the receiver confirms the corresponding application through the DST and can execute the corresponding application by using consecutive data sections received due to the confirmation.

For example, as described above, the DVB has a specific digital storage media-command and control (DSM-CC) object carousels to transmit applications.

The objects of the DSM-CC object carousel is transmitted to modules and provides a file system including a file and a directory objects in file system manner.

FIG. 1 illustrates overall configuration to show an object carousel decoding process of a general transport stream.

As shown in FIG. 1, while a server (e.g. broadcast station) transmits a transport stream periodically and sequentially, a client (e.g. a file system of a set-top box) downloads the DST at first if a power is turned on or a channel is changed at the client.

The client confirms the corresponding application to broadcast data with reference to the DST and downloads individual data sections for the corresponding application. Here, the data sections can include a download server initiate (DSI) control message, and download info indication (DII) control message and a download data block (DDB) data message.

The DSI control message can have a module identifier, information relevant to overall object carousel (a revolution period of an object carousel and timeout value of the object carousel revolution) and rout information.

The DII control message has information corresponding to each module and can include module information such as a size, a version, and a timeout value of each module.

The DDB data message can have file objects located in lower hierarchy structure of a root directory.

Accordingly, the client can analyze a directory object or a file object included in each module with reference to the DSI control message and the DII control message, and find wished file object.

The above description will be summarized in more brief as follows. If the power is turned on or the channel is changed at the client, the client (e.g. a file system of a set-top box) downloads the DST at first and decodes the DST, in other words, confirms the corresponding application, and downloads the data sections including the DII control message, the DDB data message and the DSI control message corresponding to the corresponding application.

Then, the client makes the DDB data message in separate modules with reference to the DSI control message and the DDI control message, extracts file objects by using the separate modules, and executes the corresponding application by using the file objects.

As described above, through a series of processes for receiving data with a lot of time delay, the data files for the corresponding application are extracted and provided.

Such a server transmits the directory objects and the file objects cyclically. When the power is turned on or channel is changed at the client, the directory objects and the file objects for a specific application are extracted under a predetermined grouping formula.

A data broadcast service is provided through the processes as described above. Here, it generally requires a great deal of time delay (e.g. a few or tens seconds) to download all the data sections for a specific application, extract file objects and execute application.

Accordingly, a viewer turns on the power to watch the digital broadcast or feels bored due to time delay of a corresponding data broadcast whenever a channel is changed in watching a digital broadcast.

Also, since the viewer continues to change the channel so as to avoid this time delay, the data broadcast service is delayed more and more.

### SUMMARY OF THE INVENTION

Accordingly, the present invention is directed to a data broadcasting system and operating method thereof that substantially obviates one or more problems due to limitations and disadvantages of the related art.

An object of the present invention is to provide a data broadcasting system and an operating method thereof that prevent the viewer from feeling bored by providing advertisement during receiving data with a delay.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for operating a data broadcasting system that executes a data broadcast under a client-server environment, the method comprising the steps of: (a) downloading a data service table for a specific application at the client; (b) providing an advertisement image and concurrently performing a data receiving process with reference to the data service table; and (c) executing the specific application using data files extracted through the data receiving process.

The data service table can include advertisement image-relevant information used to confirm whether an advertisement image file exists.

The step (b) may include the steps of: confirming whether the advertisement image-relevant information exists with reference to the data service table; if the advertisement image-relevant information exists, downloading at least one vendor section from the server; and executing the advertisement image file extracted from the at least one vendor section.

According to another preferred embodiment of the present invention, there is provided a data broadcasting system of executing a data broadcast under a client-server environment, wherein the system provides an advertisement image with reference to a data service table provided from a server while a client receives data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates overall configuration to show an object carousel decoding process of a general transport stream;

FIG. 2 illustrates DST section configuration in a data broadcast system according to the present invention;

FIG. 3 illustrates vendor section configuration in a data broadcast system according to the present invention;

FIG. 4 illustrates a configuration of vendor_byte of FIG. 3;

FIG. 5 illustrates an embodiment in which a vendor section is provided in a data broadcast system according to the present invention; and

FIG. 6 illustrates an AIT section configuration in a data broadcast system according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

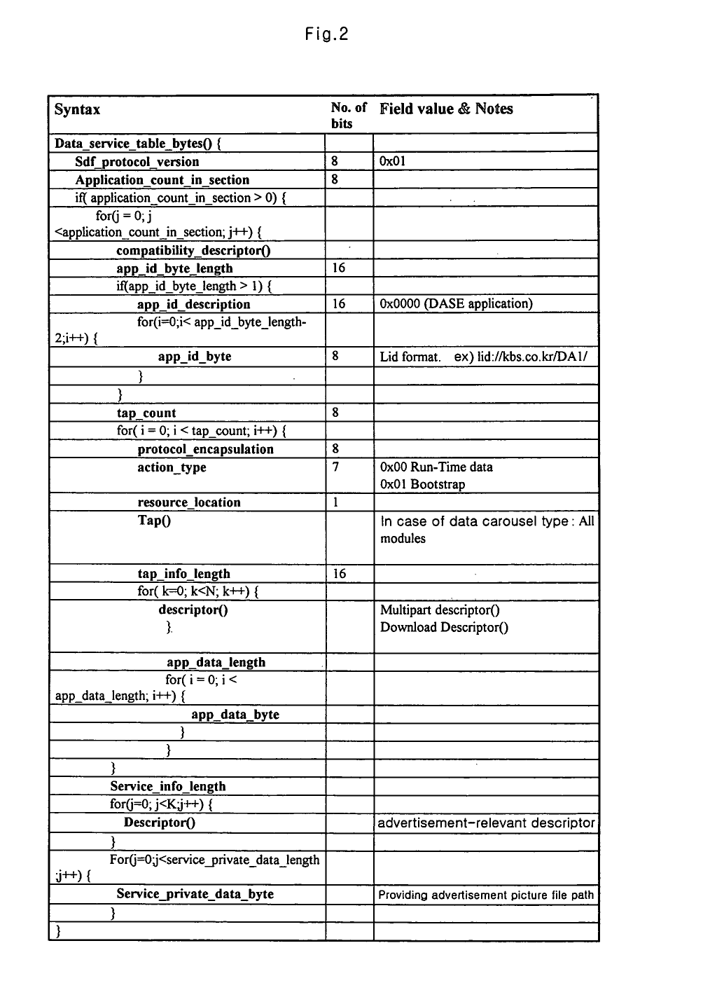

FIG. 2 illustrates DST section configuration in a data broadcast system according to the present invention.

Referring to FIG. 2, a data service table (DST) provides a specific application and includes application identifier and application-relevant information.

The DST according to the present invention adds a descriptor describing advertisement image-relevant information (e.g. advertisement image name and advertisement image path) to Service_info( ) besides an application identifier and application-relevant information so that it is confirmed that the corresponding advertisement image information exists or not. Here, if it is confirmed that the advertisement image information exists in the DST, a vendor section (vendor section( )) including an advertisement image can be downloaded.

The detailed description will be made on the DSI of the present invention. As shown in FIG. 2, an advertisement image name is described on Descriptor( ) of Service_info( ), and Service_private_data_byte portion can include an advertisement image path.

Accordingly, it can be confirmed whether the corresponding advertisement image-relevant information exists or not, through Service_info( ) of the DST of the present invention. Then, the corresponding advertisement image is extracted from the vendor section that was downloaded after the DST, and provided while the data is received.

As described above, the data used to execute the corresponding data are downloaded in many sections, and it requires considerable time to extract many data files from many data sections to provide the data files.

In the present invention, an advertisement image is provided to prevent a viewer from being bored while data are received and provided.

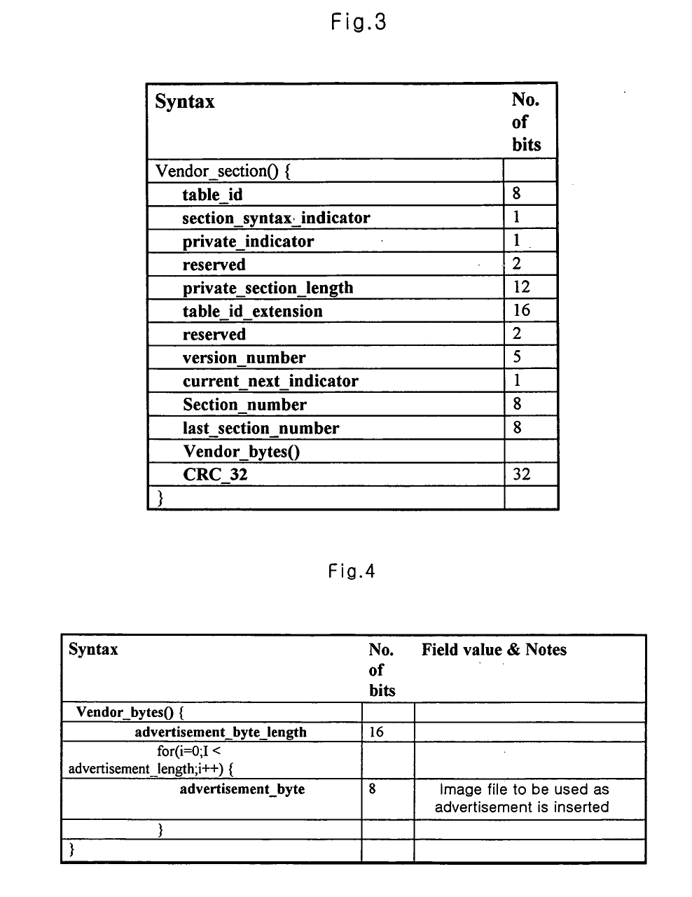

FIG. 3 illustrates vendor section configuration in a data broadcast system according to the present invention. FIG. 4 illustrates a configuration of vendor_byte of FIG. 3.

As described in FIGS. 3 and 4, the vendor section includes an advertisement image file for advertisement broadcast while data are received. Such a vendor section is downloaded when it is confirmed that the advertisement image-relevant information exists in the DST section as shown in FIG. 2. If it is confirmed that the advertisement image-relevant information does not exist in the DST section, the vendor section shown in FIG. 3 is downloaded.

Here, data information on a specific application is downloaded as a plurality data sections (DSI control message, DII control message, DDB data message) regardless of whether to receive the vendor section, and experiences a data receiving process for a predetermined time. In other words, the data sections are downloaded and configured as a module, and a file objects are extracted and provided to a specific application. Here, in the predetermined time period, the advertisement image included in the vendor section is extracted and broadcasted.

Vendor_bytes( ) of vendor section( ) can include an advertisement image to be provided to a viewer while receiving data.

Here, since such vendor section cannot exceed 4 K bytes for a section, it can be divided into a few vendor sections and transmitted according to size of an advertisement image file.

Accordingly, advertisement image files extracted from a plurality of vendor sections are combined to generate one advertisement image file, and the advertisement image file is provided to a viewer before data files extracted from data sections are broadcasted so that a viewer can watch the corresponding advertisement image and does not feel bored during a waiting time before the data files are broadcasted.

Here, since the vendor section requires no additional control message, it is not necessary to make an additional module. Then, the corresponding advertisement image files can be extracted and provided to the viewer without being affected by receiving speed.

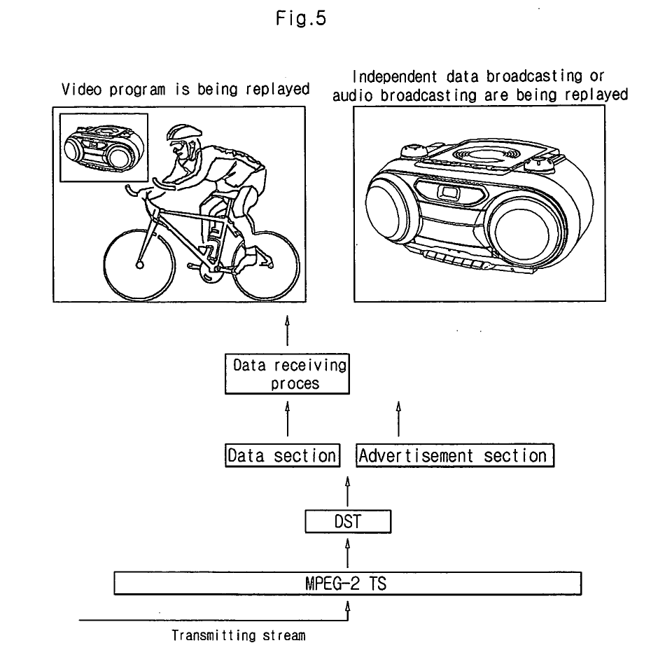

FIG. 5 illustrates an embodiment in which a vendor section is provided in a data broadcast system according to the present invention.

As shown in FIG. 5, a server (e.g. a broadcast station) transmits DST for a specific application and data sections of the DST periodically in the form of a transport stream.

Here, when the power of the client is turned on (here, the client is set for a specific application by default) or a viewer changes a channel to another channel (here, another channel is a data broadcast for a specific application), the client downloads the DST at first.

The client confirms whether an application name, application-relevant information and advertisement relevant information exist or not.

Here, if the advertisement image information exists in the DST, the client downloads at least one vendor section designated by the advertisement image information and a plurality data sections related to application included in the DST.

The client extracts the advertisement image file from the at least one vendor section to provide it to a viewer. If the size of the one advertisement image file exceeds the size of the advertisement image file extracted from the one vendor section, the at least one advertisement image file extracted from the at least one vendor section may be combined to generate and provide one advertisement image file.

Here, the advertisement image file can be outputted on a predetermined region of a screen if a video broadcast is being replayed on the screen. The advertisement image file can be outputted on a full screen if any one of an audio broadcast and an independent data broadcast is being replayed on the screen.

The advertisement image file provided by the vendor section may be a simple moving picture as well as a still image.

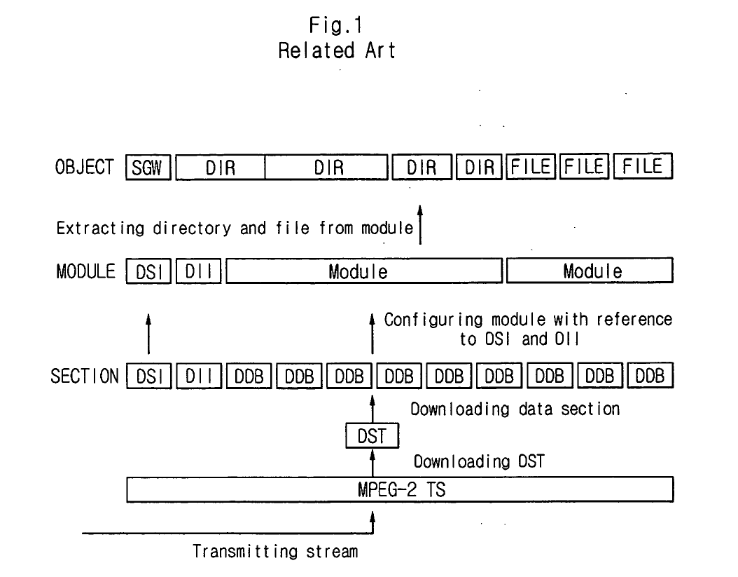

In the process described above, data are received while the advertisement image file is provided. Here, the data are received in the same manner of the conventional data receiving process shown in FIG. 1.

If a plurality data sections (DSI control message, DII control message, DDB data message) related to application included in the DST are downloaded, the client makes a plurality of modules from a plurality of DDBs with reference to the DSI control message and the DII control message.

Then, a directory object or data files included in each module are interpreted and extracted. The corresponding application is executed using the extracted data files.

Accordingly, in the present invention, the advertisement image file can be provided to prevent the viewer from being bored while data are received with considerable time delay as described above.

The present invention can contribute to activation of data broadcast since a data broadcast can be efficiently made due to provided advertisement for time delay during which data are received.

The description is made on the basis of North American DST structure but it should be noted that the present invention could be applied to European ACAP or AIT structure of OCAP.

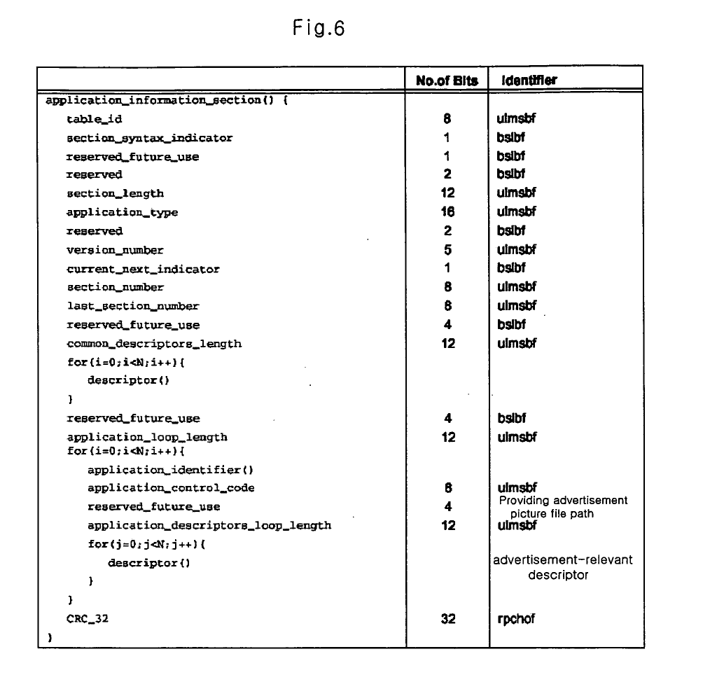

In other words, as shown in FIG. 6, application information table (AIT) provides a specific application service, and includes the application identification and information on the application.

Besides application identification and application-relevant information, the descriptor( ) describing advertisement image-relevant information (e.g. advertisement image name and advertisement image path) is added to the AIT according to the present invention. Therefore, it can be confirmed whether the corresponding advertisement image-relevant information exists in the AIT. Here, if the advertisement image-relevant information exists in the AIT, vendor section( ) defined beforehand as shown in FIG. 3 including the advertisement image can be downloaded.

In more detailed description, in the AIT of the present invention, an advertisement image name is described in the descriptor( ) and advertisement image-relevant information can be included in reserved_future use portion.

Accordingly, it is confirmed whether the corresponding advertisement image-relevant information exists, through descriptor( ) of the AIT of the present invention. The corresponding advertisement message can be extracted from the vendor section( ) downloaded after the AIT and provided while the data are received.

Accordingly, in the present invention, the viewer can easily access to the data broadcast by watching advertisement provided during receiving the data of the corresponding application.

In the present invention, since it is paid from an advertiser by providing advertisement to the data broadcast, a new interest infrastructure can be created and furthermore the quality of data broadcast can be improved.

In the present invention, since character or logo for public information as well as advertisement can be inserted, the data broadcast can be applied variously.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for operating a data broadcasting system that executes a data broadcast under a client-server environment, the method comprising the steps of:
(a) downloading a data service table for a specific application at the client;
(b) providing an advertisement image and concurrently performing a data receiving process with reference to the data service table; and
(c) executing the specific application using data files extracted through the data receiving process.

2. The method according to claim 1, wherein the data service table comprises advertisement image-relevant information used to confirm whether an advertisement image file exists.

3. The method according to claim 2, wherein the step (b) comprises the steps of:
confirming whether the advertisement image-relevant information exists with reference to the data service table;
if the advertisement image-relevant information exists, downloading at least one vendor section from the server; and
executing the advertisement image file extracted from the at least one vendor section.

4. The method according to claim 1, wherein the advertisement image is generated by a combination of the advertisement image files extracted from the at least one vendor section.

5. The method according to claim 1, wherein the advertisement image is comprised of any one selected from the group consisting of a still image or a moving picture.

6. The method according to claim 1, wherein the advertisement image is outputted on a predetermined region of a screen if a video broadcast is being replayed on a screen.

7. The method according to claim 1, wherein the advertisement image is outputted on a full screen if any one of an audio broadcast and an independent data broadcast is being replayed on a screen.

8. The method according to claim 1, wherein, when a power is turned on or a channel is changed at the client, a data broadcast for the specific application begins.

9. A data broadcasting system of executing a data broadcast under a client-server environment, wherein the system provides an advertisement image with reference to a data service table provided from a server while a client receives data.

10. The system according to claim 9, wherein the client receives data from the time of downloading a plurality of data sections relevant to an application included in the data service table to the time of providing a plurality of final data files to the application.

11. The system according to claim 9, wherein the data service table comprises application-relevant information and advertisement image-relevant information.

12. The system according to claim 9, wherein the client determines whether to download an advertisement image file on the basis of the advertisement image-relevant information.

13. The system according to claim 9, wherein the advertisement image is comprised of any one selected from the group consisting of a still image or a moving picture.

14. The system according to claim 9, wherein the advertisement image is outputted on a predetermined region of a screen if a video broadcast is being replayed on a screen.

15. The system according to claim 9, wherein the advertisement image is outputted on a full screen if any one of an audio broadcast and an independent data broadcast is being replayed on the screen.

16. The system according to claim 9, wherein, when a power is turned on or a channel is changed at the client, a data broadcast for the specific application begins.
